(19) United States
(12) Patent Application Publication
(10) Pub. No.: US 2019/0010686 A1
(43) Pub. Date: Jan. 10, 2019

(54) Pipe unclogging device and Attachments

(71) Applicants: Darrel Hughes, Staten Island, NY (US); Keith Cummings, Staten Island, NY (US)

(72) Inventors: Darrel Hughes, Staten Island, NY (US); Keith Cummings, Staten Island, NY (US)

(21) Appl. No.: 15/645,968

(22) Filed: Jul. 10, 2017

(51) Int. Cl. E03C 1/308; A47L 7/00; A47L 5/36; A47L 9/24; A47L 9/32; A47L 9/28; A47L 9/00; A47L 5/14; B08B 9/035; B08B 9/032

(52) U.S. Cl. CPC E03C 1/308; A47L 7/009; A47L 5/365; A47L 9/248; A47L 9/242; B08B 9/0325; A47L 9/2857; A47L 9/009; A47L 7/0004; A47L 5/14; B08B 9/035; A47L 9/327

(57) ABSTRACT

The current invention is a Modified wet/dry vacuum/water jet cleaner is designed to remove standing water from plumbing by pushing and pulling trapped water-in the forward position, it is a blower, in reverse, it is a vacuum. The cleaner provides users with an easy and efficient way to ensure that pipes are clear.

### CROSS-REFERENCES TO RELATED APPLICATIONS (IF ANY)

None.

### BACKGROUND

### 1. Field of the Invention

This invention relates to a unclogging device and more particularly one with Multiple Purpose Functionalities.

### 2. Description of Prior Art

Currently in the industry there are vacuums such as a shop vacuum, which does handle the average messes, but will not handle any type of plumbing messes. Having Plumbers to come out to unclog lines after plunging does not work is very expensive and time consuming.

There is still room for improvement in the art.

### SUMMARY OF THE INVENTION

The current invention is a shop vacuum that has multiple functions and attachments.

The current invention is a device that allows a user to unclog pipes and toilets. The current invention is a shop vacuum unit 1 and attachments that is comprised of an ergonomic cylindrical base with a exchangeable carousel connected to the top of the base with a rounded dome cover with a handle on the top. The unit sits on a platform with wheels for ease of mobility.

It is an improvement over the current art.

### BRIEF DESCRIPTION OF THE DRAWINGS

Without restricting the full scope of this invention, the preferred form of this invention is illustrated in the following drawings:

FIG. 1 is a view of the current invention and it's components;

FIG. 2 is a rear view of the current invention;

FIG. 3 displays a rear view with the plug area;

FIG. 4 shows the control panel; and

FIG. 5 shows a plunger hose combination.

### DESCRIPTION OF THE PREFERRED EMBODIMENT

There are a number of significant design features and improvements incorporated within the invention.

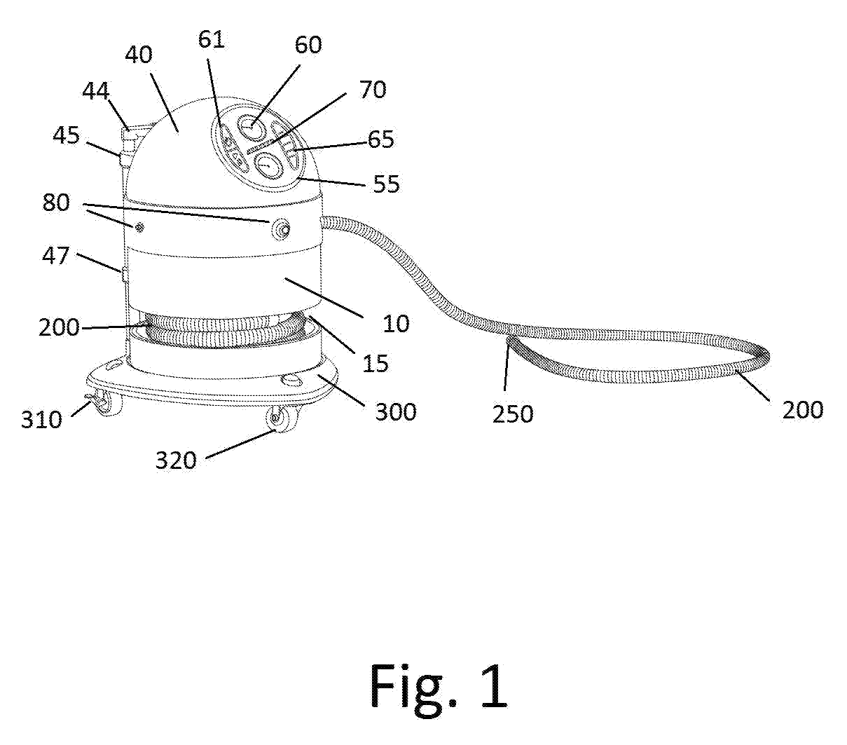

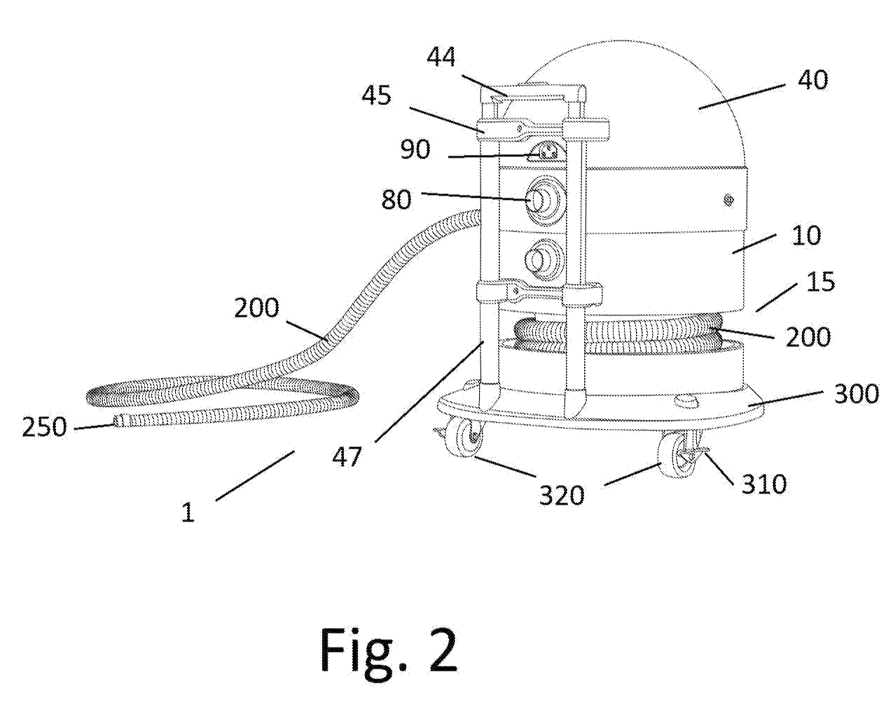

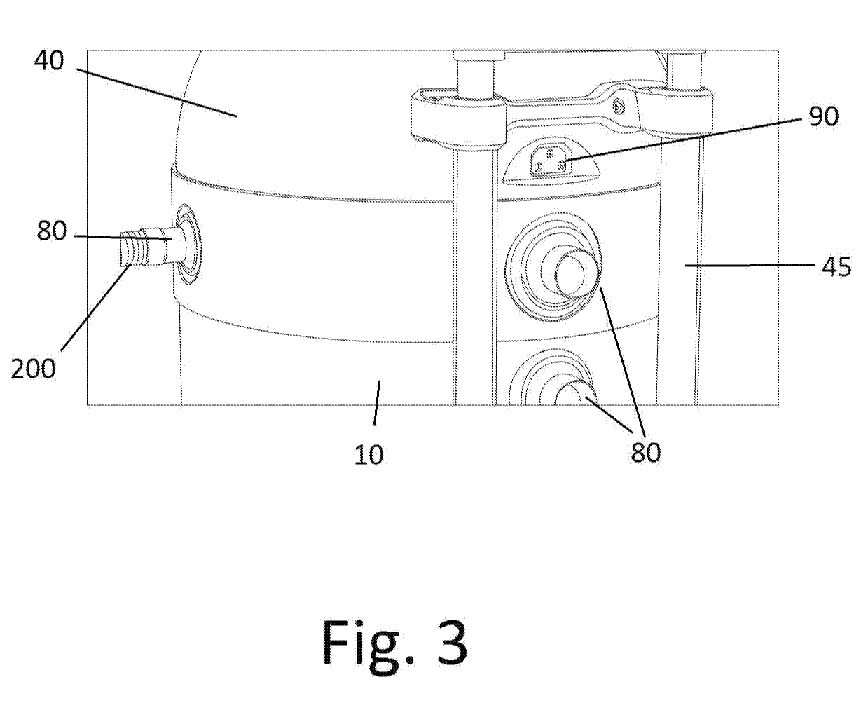

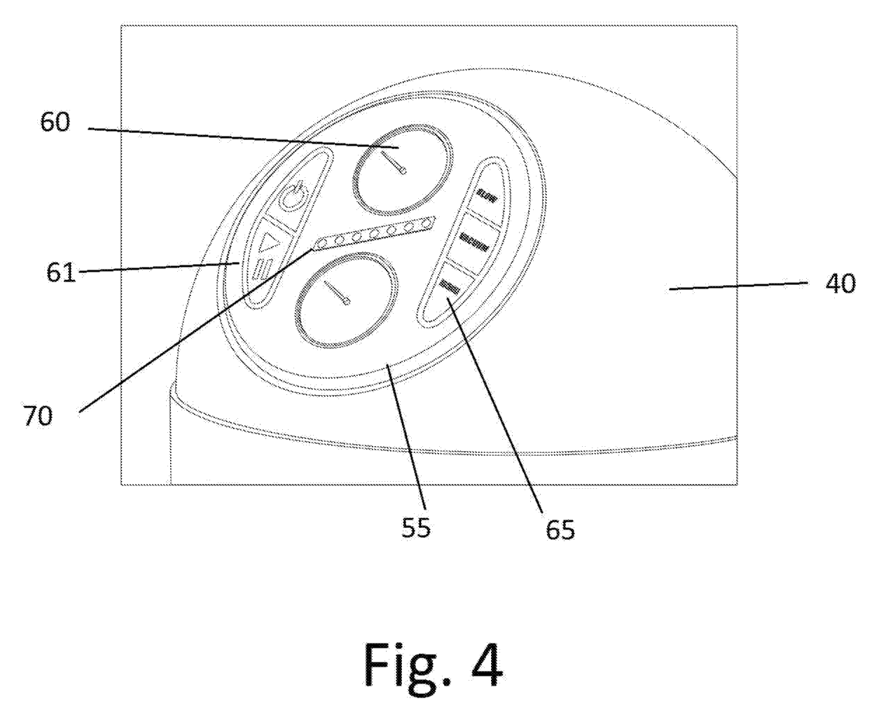

The current invention is a shop vacuum unit 1 and attachments as shown in FIGS. 1-4. It is comprised of an ergonomic cylindrical base 10 with a exchangeable carousel 30 connected to the top of the base 10 with a rounded dome cover 40 with a flat control panel 55 in the front of the cover 40. The general dimensions now are: 12″ diameter, 20″ high with 2″ diameter wheels 320.

The unit 1 consists of a cylindrical base tank 10, vacuum/blower, plunger extension 80, and hoses 200 with attachments 250 in different sizes. The base 10 has a bottom wall and a perimeter wall that extends upward from said bottom wall. In the preferred embodiment, the circumference of the base tank would be 15″.

The blower pump and vacuum pump motor is located beneath the cover 40. The cover 40 is removable to allow access to the inside of the base 10 which serves as a water holding tank.

The unit 1 acts as a wet/dry vacuum jet that makes it easier to remove standing water from affected pipes (copper, PVC, steel, brass). In the forward position, the unit 1 used as a blower and in the reverse position, it is used as a vacuum. The unit 1 moves water back and forth in the pipe or toilet to efficiently remove a clog or blockage.

In the preferred embodiment, the standard design measures 4 feet tall and has a circumference of 4 feet, 6 inches; capacity is 20 gallons (6.5 Hp, 265 mpb blower).

Domed cover 40 consists of a cover 40 with a control panel 55 that features an LED meter 70 and two PSI gauges 60 as well as an on/off switch 68 and a vacuum/blower switches 65. The gauges 60 and the LED meter 70 will alert the user if anything was caught while suctioning.

A carousel 30 is positioned toward the center of the unit 1. The carousel features a sleeve with four differently sized nozzles 80. The carousel rotates' 360 degrees to ensure that the correct nozzle 80 is available and positioned in front of the main vacuum hole 20. The vacuum hole 20 will line up with the vacuum intake. The blower pump will connect the vacuum intake with a vacuum outtake which will place the water sucked up into the base 10 which will have a water holding tank. Water is pulled from the water holding tank when the unit 1 blows water out to through the hose 200.

In the preferred embodiment, there are two carousel sleeves; the first sleeve fits the following sizes: ¼ inch, ½ inch, ¾ inch and 1-inch diameters and the second sleeve fits the following sizes: 1¼ inch, 1½ inch, 1¾ inch and 2-inch diameters with the nozzles extending out from the sleeve.

A smaller snake-like hose 200 is included and may be used to unclog toilets, bathtubs and sinks. The snake would measure 20 feet long in the preferred embodiment and comes in two sizes in the preferred embodiment, ¼-inch and ½-inch diameters. The snake hose 200 also features a bend near the end of the hose 200. The snake hose 200, in the preferred embodiment, will be made of an interior aluminum tubing lined with inner and outer layers of UV resistant polyethylene (PE). It is a durable, reliable tubing that will not corrode or rust. The flexibility of gasFlex tubing results in easy rollouts.

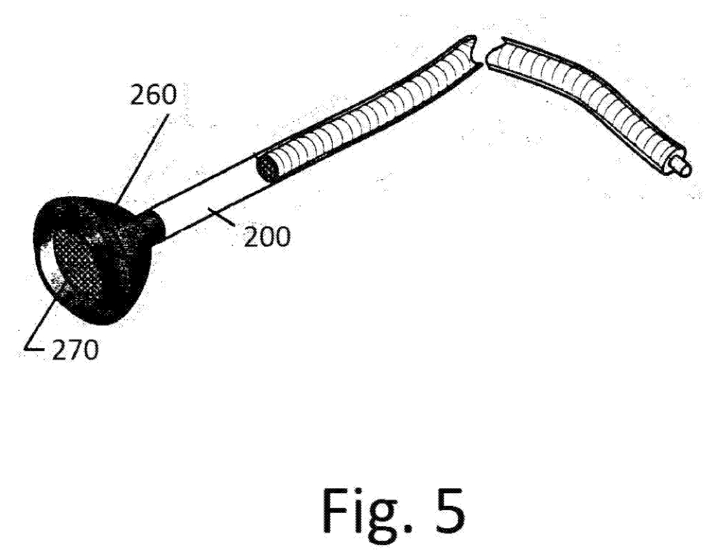

The unit 1 would have a hose/plunger extension 260 with a screen 270 includes a 2-foot handle and 6 feet of ¾-diameter hose as shown in FIG. 5. The hose 200 may be of particular sized to plug drains of pipes or toilets to allow for efficient suction of water from these articles or for forcing air or water into them. For this reason, the hose 200 will have a connector 250 to which is attached a hemi-spherical shaped applicators 260 with a screen 270 which resemble a plunger and have a size for fitting over the drain of a toilet. The hose 200 has a first end and a second end. A plurality of connectors 80 is removably couplable to the first end to fluidly couple the first end to one of the couplers. An extension 260 is removably coupled to the second end to alter a shape and dimension of the second end. The handle 44 extends out in a way similar to luggage handles and are collapsible into the handle frame 45 which is connected to the base 10 in the back of the base 10.

The unit 1 will have an extendable handle 44 that extends from the back of the base 10

The unit 1 would have a power source which would be a detachable power cord which attached to an electric plug 90. It will also have a car lighter adaptor and an optional USB Power Cord.

The unit 1 will sit will have a platform 300 which the base 10 will sit. This will provide to support and transport the base 10. The platform 300 will have a plurality of wheels 320 with locking mechanisms 315 to lock the wheels 320. The wheels 320 are rotatably coupled to and extend downwardly from the platform 300. The hard cart 300 will have hart cart handle 310 is attached to and extends upwardly from the cart base. The platform 300 will have a rubber bumper at it edges for protection from hitting the unit 1 against anything.

Between the base 10 and the platform 300, the unit 1 will have the hose storage area 15. The hose storage area 15 has a smaller circumference than the base 10 and the top of the platform 300 forming an secure area where the hose 200 can be stored when not in use.

In addition to plumbing capabilities the invention can be used to clean up after the children and after parties, after mechanic work as it offers all the traditional shop vacuum cleaning with the additional plumbing capabilities. The unit may also be used as a fire extinguisher for fire safety, or for use when flushing liquid out of an automobile's radiator.

### Advantages

Not like the after effects, of an hand auger or electric snake, that would leave scratches. It also Extends and Retracts and there's a rule by foot on the snake, that allows a user to get a guesstimate of how far their clog may be. Also being indicated on the meter and gauges.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A drain pipe clearing device to remove water from or eject water or air into a pipe, said device comprising:
a base having a bottom wall and a perimeter wall being attached to and extending upwardly from said bottom wall;
an exchangeable carousel which being rotatably mounted on the top of base, said carousel having a plurality of openings extending therethrough, said openings being selectively align able with said aperture by rotating said primary carousel;
a plurality of hoses, each of said openings having one of said couplers fluidly coupled thereto;
a cover being mounted on said base and closing said access;
a blower being mounted to said cover said blower being operational in a blowing mode to blow water out of said housing or in a suction mode to suction water into of said housing;
at least one flexible hose having a first end and a second end; and
an applicator being removably coupled to said second end of said hose to alter a shape and dimension of said second end.

2. A device according to claim 1 further comprising:
Having a platform on which the base sits into.

3. A device according to claim 2 further comprising:
Having the platform have wheels on the bottom.

4. A device according to claim 2 further comprising:
Having an extendable handle.

5. A device according to claim 4 further comprising:
Having the handle connect to the back of the base.

6. A device according to claim 1 further comprising:
Having the applicator have a screen.

7. A device according to claim 1 further comprising:
Having the applicator be plunger shaped.

8. A device according to claim 1 further comprising:
Having two carousel sleeves; the first sleeve 30 fits the following sizes: ¼ inch, ½ inch, ¾ inch and 1-inch diameters and the second sleeve 35 fits the following sizes: 1¼ inch, 1½ inch, 1¾ inch and 2-inch diameters.

9. A device according to claim 1 further comprising:
Having a control panel on the cover.

10. A device according to claim 9 further comprising:
Where control panel has an on and off switch, a blower and vacuum switches.

11. A device according to claim 9 further comprising:
Where control panel has an LED meter and a plurality of gauges.

12. A device according to claim 2 further comprising:
Where the platform has a rubber bumper.

13. A device according to claim 1 further comprising:
Where the hoses are made of an Interior aluminum tubing lined with inner and outer layers of UV resistant polyethylene (PE).
